(19) United States
(12) Patent Application Publication
(10) Pub. No.: US 2022/0315247 A1
(43) Pub. Date: Oct. 6, 2022

(54) INTEGRAL FLOOR MODULE, CARGO LOADING SYSTEM, LATCH ELEMENT AND METHOD FOR CONVERTING A PASSENGER DECK INTO A CARGO DECK

(71) Applicant: TELAIR INTERNATIONAL GMBH, Miesbach (DE)

(72) Inventors: Thomas HUBER, Schliersee (DE); Richard HOLZNER, Stephanskirchen (DE)

(21) Appl. No.: 17/710,380

(22) Filed: Mar. 31, 2022

(30) Foreign Application Priority Data
Apr. 2, 2021 (DE) 102021108473.3
Jun. 11, 2021 (DE) 102021115146.5

(51) Int. Cl. B64F 1/32; B64C 1/20; B64D 9/00

(52) U.S. Cl. CPC B64F 1/322; B64C 1/20; B64D 9/003; B64D 2009/006

(57) ABSTRACT

An integral floor module for a cargo deck comprising: a first and second support section for (planar) support on support sections of perforated rail device, wherein the support sections extend in a longitudinal direction and define a support plane; a flat functional device receiving section, which is formed (centrally) between the support sections, wherein the functional device receiving section extends in a longitudinal direction and defines a (lower) receiving plane; wherein the floor module is designed in such a way that the receiving plane is clearly spaced apart (downwards) from the support plane. The floor module can be used in a cargo loading system, including with a latch element, and a method for converting a passenger deck into a cargo deck.

### CROSS REFERENCE TO RELATED APPLICATIONS

This application claims priority to German Patent Application No. 102021108473.3, filed Apr. 2, 2021, and German Patent Application No. 10 2021 115 146.5, filed Jun. 11, 2021. The disclosures set forth in the referenced applications are incorporated herein by reference in their entireties.

### FIELD OF THE DISCLOSURE

The invention relates to an integral floor module, a cargo loading system, a latch element, and a method for converting a passenger deck of an aircraft into a cargo deck.

### BACKGROUND

Aircraft are normally used for different purposes in the course of their service life. Aircraft used to transport passengers are primarily used to transport cargo or freight after an appropriate period of use. The aircraft may generally have a main deck and a lower deck in which cargo is transported during the use of the aircraft for passenger transport.

When transporting cargo in aircraft, cargo items, e.g. containers or pallets (“Unit Load Devices—ULDs”) are often used, which are cuboid or trapezoidal or have a shape with a special outer contour. Such containers or pallets can be loaded longitudinally or transversely, depending on the aircraft's cargo space. Thus, for containers and pallets, for example for civil aviation, there are the following standard sizes relevant in the context of this application. The following standardized dimensions of the containers and pallets are each given in length×width×height.

Containers and pallets (“ULDs”) are classified by three letters, as is generally known, according to a regulation of the “International Air Transport Association” (IATA). Only the most important ones are explained below:
The first letter defines the type of cargo. The letter A indicates a certified container or the letter P indicates a certified pallet with net combination;
the second letter provides information about the floor size, i.e. the base area of the cargo item, and
the third letter describes the contour or the type of construction of the cargo.

Containers and pallets for transport in the main deck of an aircraft have essentially the following standardized dimensions:
223.5×317.5×243.8 cm (88×125×96 inches). These dimensions apply to AAJ containers and PAG pallets;
223.5×317.5×208.2 cm (88×125×82 inches). Such dimensions are used for AAA, AAC, AAY and AAZ containers and PAG pallets;
243.8×317.5×243.8 cm (96×125×96 inches). Such cargo items are known as AMA and AMJ containers and PMC pallets;
243.8×497.8 cm (96×196 inches) or 243.8×605.7 cm (96×238.5 inches).

These dimensions correspond to the footprint of pallets with a specific contour resulting, for example, from the contour of an engine or vehicle or special cargo. Such pallets are conventionally referred to as PRA or PGA pallets;
223.5×274.3 cm (88×108 inches) and 137.1×223.5 cm (54×88 inches).

As a result of the Corona pandemic, air passenger traffic has been very severely curtailed. This inevitably means that high capacities of lower-deck cargo transport volumes are lost. At the same time, Internet trade continues to grow steadily (now partly due to the pandemic). Consequently, cargo capacity on aircraft is becoming increasingly scarce. All purely cargo aircraft are currently flying at the limit of what is possible. Some airlines are now using passenger planes as cargo planes. For example, the seats (and possibly also galleys) on the main deck are removed and cargo is simply attached to the floor using lashing nets.

However, this only allows the cargo to be loaded and secured quickly and safely to a limited extent. In addition, the available volume is not optimally utilized in this way.

In general, the design of a cargo deck has to meet conflicting demands for great stability and low weight. In addition, neither the individual components nor the installation of the same must be too elaborate when retrofitting, as this increases costs. Ultimately, the cargo deck must be highly functional, flexible in use, and protected against faulty operation. Every minute an aircraft spends on the ground due to component failure generates high costs for operators.

### SUMMARY

The invention is based on the object of providing a floor module as well as a cargo loading system, a latch element as well as a method for converting a passenger deck into a cargo deck, which allows to provide a (fully) functional cargo deck quickly and easily.

In particular, the object is solved by an integral floor module for a cargo deck, preferably made of a fiber composite material, wherein the floor module comprises:
a first and second support section for (flat) support on support sections of perforated rail devices, wherein the support sections extend over a longitudinal direction and define a support plane;
a preferably flat functional device receiving section, for example for holding a roller drive unit, which is formed (centrally) between the support sections, wherein the functional device receiving section extends in the longitudinal direction and forms a receiving plane;

characterized in that

the floor module is designed in such a way that the receiving plane, preferably extending parallel to the support sections, is clearly spaced apart (downwards) from the support plane.

The clear spacing can amount to a value of 1 cm or more. In particular, the spacing can be between 6 mm and 32 mm, preferably between 12 mm to 26 mm, further preferably 19 mm. Specifically, a spacing can be 19.05 mm (0.75 inch) due to different system heights of mechanical (1.25 inch, 3.175 cm) and roller drive units (2 inch, 5.08 cm). However, clear spacing can also be defined alternatively as relative values, for example, with respect to the overall system height or individual components of the cargo system. For example, clear spacing may be defined as being greater than 10%, more particularly greater than 20%, more particularly greater than 30% of the mounting height of the perforated rail device and/or greater than 10% or 20% of the distance between the cross member and the support plane.

One idea of the invention is to use usually unused space underneath conventional floor modules to provide functional devices. This can be done at selected locations, e.g. in areas where roller drive units or particularly bulky latch units, e.g. center guide latches, are required. The overall system height of the cargo deck can thus be reduced, resulting in a significant weight reduction.

A (further) idea of the invention is to provide a fast and reliable conversion of a passenger deck to a cargo deck that allows loading and securing ULDs, especially on the main deck.

The floor modules can be used advantageously in conjunction with a (modular) cargo system that can be used in conjunction with existing passenger aircraft floor structures without major conversion work. This allows for easy installation and provides flexibility with respect to cargo configurations without having to modify or reinstall significant support or anchoring structures. Thus, according to the invention, already installed perforated rail devices are to be further used to anchor the cargo system.

The use of suitable materials and appropriate dimensions of the floor module and the functional equipment, as well as partial recessing of the functional equipment, saves weight and gains loading height.

A flat functional device receiving section is a specific area where a functional device is or can be mounted self-supporting on the floor module, but also an area that creates free space (downwards, in the z-direction) so that a functional device can protrude into it.

In one embodiment, a first end (in the longitudinal direction) of the floor module has a raised or upwardly facing formed connection area and/or a second end of the floor module has a downwardly lowered formed connection area, in particular in such a way that two floor modules can be connected in an overlapping manner, preferably screwed together in an overlapping manner. Corresponding edge regions are known, for example, from DE 10 2018 108 950 B3, which uses these edge regions to connect plane floor modules in a materially bonded manner.

Thanks to the modular design of the floor modules, a length of the corresponding cargo deck can be lengthened or shortened as required and can thus be flexibly applied to different aircraft types (with different deck lengths) or even allows only partial areas of a deck (for example, half or a third of the deck length) to be fitted with them. Retrofitting or subsequent design changes can also be implemented particularly easily and, above all, quickly in this way. A “layover period” during which the aircraft is being refitted or maintained can thus be significantly reduced.

In one embodiment, the support sections have (in each case) at least one opening, wherein these openings are designed in such a way that, in an arranged state of the floor module, direct access to the respective perforated rail device, in particular at least a subsection of an engagement slot (on the top side) of the respective perforated rail device, is possible in order to anchor (positively) the floor module itself and/or a functional device which preferably spans the floor module at least partially.

This enables the floor module to be assembled quickly without requiring many additional processing steps of the components already present (in the aircraft). Already by inserting the floor modules in such a way that the sections of the engagement slot protrude into the openings of the floor modules, these are suitably aligned. Furthermore, fixing in the longitudinal direction and/or in the transverse direction of the aircraft can be achieved by a form fit between the edges of the opening and the engagement slots.

The openings also help reduce the mass of the floor module to keep the overall weight as low as possible.

In one embodiment, the floor module has a plurality of cable fastening devices, e.g. cable clips, on an underside, which serve to guide and/or hold at least one cable. Furthermore, at least one, in particular sealed, cable passage may be provided on the upper side of the floor module.

This allows cables to be pre-installed for the operation of functional equipment provided on the floor module, in particular roller drive units. This increases modularity and further reduces the work steps required to convert a passenger deck. In addition, this allows a defined cable route to be created so that a required cable length is reduced to a minimum.

In one embodiment, the functional device receiving section or at least a partial area of the functional device receiving section is designed for drainage, in particular as a drainage channel for liquid. Here, the modularity of the floor modules already described proves to be an advantageous embodiment.

The fact that ultimately the floor module (itself) is or can be designed as a drainage (channel) (optionally without further or comparatively few fluid conducting structures) means that (rain) water or (in general) fluids that have reached the cargo deck can be easily drained off. The described lowering of the functional device receiving section forms a natural channel that drains fluid longitudinally, optionally along the entire length of the cargo deck.

To form the channel, the entire functional device receiving section can be flat. However, it is also conceivable to provide concave sections, for example between mounting areas for functional devices, in particular roller drive units. According to the invention, it is also possible to form the entire functional device receiving section or the entire channel in a concave manner if the functional device has essentially a corresponding shape on its underside.

In one embodiment, the functional device receiving section has at least one drainage device, wherein the drainage device(s) is/are preferably designed as a hose and/or pipe connection, and/or the functional device receiving section of the floor module has at least one inspection opening, wherein the inspection opening is preferably arranged in the vicinity of one end in the longitudinal direction of the floor module and is closable with a cover (fluid-tight).

Preferably, the inspection opening is arranged and formed in such a way that one end of the cable, in particular a plug or a plug or a socket on the cable, and/or the drainage device is accessible through the inspection opening.

This further improves the overall handling of the floor module or maintenance of an installed floor module. Important components (electrical and fluid connections) are thus stored in a connection area of floor modules in an easily accessible manner (for maintenance or subsequent retrofitting). In addition, this basically enables further pre-assembly steps, such as pre-assembly of a hose system, which in turn saves time during the actual assembly of the floor module and thus reduces the aircraft's downtime.

In one embodiment, at least one reinforcement area is provided for reinforcing or stiffening the floor module, for example by one or more reinforcing elements, which are preferably arranged in the area of the functional device receiving section.

In one embodiment, such an element can be mounted on the floor module and/or is formed by a core element (for example, a foam core or the like) or (composite) core structure that can be integrated into the floor module, e.g. by a (sectional) layer increase. Alternatively or additionally, a reinforcement area can also be formed by connecting (for example, screwing) a functional device to the floor module.

In this way, (vertical) loads acting on the floor module (for example of the roller drive units) and/or a corresponding load distribution can be optimized. Overall, this further improves the handling as well as the load capacity of the floor module.

In particular, the problem according to the invention is also solved by a cargo loading system for an aircraft, wherein the cargo loading system comprises:
a plurality of perforated rail devices extending in the longitudinal direction of the aircraft; and
at least one floor module as previously described, arranged on at least support sections of at least one pair of perforated rail devices.

This results in the same advantages as already described in connection with the integral floor module.

In addition, it should be noted here that the features and advantages described in the context of the floor module according to the invention also apply to the cargo loading system according to the invention. Features of the floor module are transferable to the cargo loading system according to the invention.

In one embodiment, the perforated rail device, or a pair of perforated rail devices, have, particularly at regular intervals, sections of engagement slots into which the openings corresponding in the arranged state of the floor module engage.

Preferably, the engagement slot comprises a plurality of (fastening) holes and/or projections, and in particular, on each side of the perforated rail device, a support section for supporting the support sections of the floor module, wherein the support sections are preferably arranged lower than the upper side of the perforated rail.

This allows the floor module to be mounted quickly and easily in just a few steps.

Appropriate engagement of the engagement slot ensures that the floor module is arranged in a stable manner even under the influence of acceleration forces and cannot slip. In addition, further functional devices can be mounted on the perforated rail devices (through the openings), so that flexible arrangement, rearrangement (into other configurations) or refitting of the cargo lanes is made possible quickly and easily.

In one embodiment, at least two floor modules are longitudinally connected to each other in a (partially) overlapping manner, in particular fluid-tight, preferably plugged together, in such a way that the respective functional device receiving sections or partial areas thereof form a (common) drainage channel, in particular a drainage channel for draining off liquid.

The formation of a single (common) continuous drainage channel offers the advantage that (in total) only two drainage devices are required—one at a forward end of a cargo lane (comprising a plurality of floor modules) and one at an aft end of that cargo lane. Thus, instead of individual drainage pans (as is customary), a single drainage channel is obtained, which may extend substantially from the front to the rear of the aircraft. This is an advantageous way to save material and mass and reduce complexity.

The object according to the invention is likewise solved by a cargo loading system having a plurality of functional devices, wherein the functional devices comprise in particular a plurality of roller drive units, a plurality of longitudinal guide latch elements and/or a plurality of central guide latch elements, wherein at least a plurality of the functional devices is fastened to the perforated rails, and/or at least a subset of the roller drive units is fastened to the floor module, in particular in the functional device receiving section.

This results in the same advantages as already described in connection with the integral floor module and/or the corresponding cargo loading system.

In addition, it should be noted here that the features and advantages described in the context of the floor module or cargo loading system according to the invention also apply to the cargo loading system according to the invention having a plurality of functional devices. Features of the floor module or the cargo loading system are transferable to the cargo loading system according to the invention having a plurality of functional devices.

In one embodiment, center guide latch elements and side guide latch elements or side guide elements are arranged and configured for setting a first and a second loading configuration.

This increases the flexibility with regard to a cargo to be accumulated and transported (for example with regard to cargo density, (total) weight or container dimensions) and further improves the handling of the cargo loading system.

In one embodiment, different loading configurations can be set in sections in the longitudinal direction of the aircraft.

In particular, at least two loading configurations—a centerline configuration and a side-by-side configuration or a combination of these configurations—can be set. This allows flexibility to be further optimized.

In one embodiment, the center guide latch elements, in particular as described below, each have at least one latch, wherein the stop surfaces of the latch or latches are clearly spaced apart, in particular between approx. 2 cm (or 19 mm or approx. 0.75 inch) and 50 cm (approx. 20 inch), preferably between 7 cm and 12 cm, further preferably approx. 10 cm (or approx. 4 inch).

On the one hand, this provides sufficient space for the corresponding roller tracks. On the other hand, the spacing can be optimized to a ULD container or plate size. In this way, the loading process can be optimized—both in terms of optimum cargo space utilization and the corresponding loading time.

In one embodiment, roller drive units (respectively) are arranged between two (longitudinally successive) center guide latch elements and/or on the functional device receiving sections.

In this way, a loading process can be optimized. In addition, the roller drive units are arranged in a protected manner. This is also advantageous, for example, if they are not (supposed to be) used for a corresponding loading configuration and containers are pushed (by hand).

Preferably, the roller drive units (each) have an optical sensor for detecting a container or the like, and preferably each roller drive unit (individually) is movable into an operating position or a rest position based on signals from the sensor.

This is particularly advantageous for a side-by-side configuration. Here (as described above), the center guide latch elements result in an approx. 4-inch free space between the containers (ULDs). If the sensor does not detect a container floor (in this free space), the roller drive unit remains in a rest position (with the rollers lowered). This protects the roller drive units from misuse and does not damage them in the side-by-side configuration.

The object according to the invention is likewise solved by a latch element, preferably center guide latch element, for securing containers or the like on a cargo loading system, in particular as described above, wherein the latch element has the following:
a, preferably integral, frame,
at least one, preferably two, latch(es) attached to the frame, preferably hinged latch(es), for holding and/or guiding containers or the like in a spaced manner, each having a claw and a stop surface,
wherein the frame has the following:
a first and second frame support section for (flat) support and/or mounting on a pair of perforated rail devices, wherein the frame support section defines a frame support plane;
a central section within which the latches are mounted, wherein a lower end of the central section extends below the frame support plane.

This results in the same advantages as already described in connection with the integral floor module and/or the corresponding cargo loading system.

In addition, it should be noted here that the features and advantages described in the context of the floor module according to the invention or the cargo loading system also apply to the latch element according to the invention. Features of the floor module or the cargo loading system are transferable to the latch element according to the invention.

The object according to the invention is also solved by a method for converting a passenger deck into a cargo deck, wherein the method comprising the following steps
disassembling at least a subset of original floor modules of the passenger deck;
arranging one or more modified floor modules between at least two perforated rail devices;
attaching the modified floor modules preferably to the perforated rail devices;
attaching at least one functional device to (the) perforated rail device(s);

wherein the functional device and/or the modified floor modules are formed and arranged in such a way that they protrude (significantly) at least in sections into an area below the dismantled original floor modules.

This results in the same advantages as already described in connection with the integral floor module and/or the corresponding cargo loading system and/or the latch element.

In addition, it should be noted here that the features and advantages described in the context of the floor module according to the invention or the cargo loading system or the latch element also apply to the method according to the invention for converting a passenger deck into a cargo deck. Features of the floor module or the cargo loading system (with a plurality of functional devices) or the latch element are transferable to the method according to the invention.

Likewise, features of the method according to the invention can be transferred to the floor module, cargo system or latch element according to the invention by configuring the corresponding device in such a way that it is suitable for carrying out the corresponding method features.

Preferred embodiments of the invention are disclosed herein.

### BRIEF DESCRIPTION OF THE DRAWINGS

In the following, the invention is also described with respect to further details, features and advantages, which are explained in more detail with reference to the figures. The described features and combinations of features, as shown below in the figures of the drawing and described with reference to the drawing, are applicable not only in the combination indicated in each case, but also in other combinations or on their own, without thereby departing from the scope of the invention, wherein:

FIG. 1 shows a schematic view of an exemplary embodiment of a floor module according to the invention;

FIG. 2 shows a schematic view of a cross-section of an exemplary embodiment of a floor module according to the invention in assembled state or arranged on perforated rail devices;

FIG. 3 shows an enlarged detailed view from FIG. 2;

FIG. 4 shows a view of a bottom surface of an exemplary embodiment of a floor module;

FIG. 5 shows a schematic view of an exemplary embodiment of a floor module according to the invention with reinforcing or stiffening areas;

FIG. 6 shows a schematic view of an alternative exemplary embodiment of a floor module according to the invention with reinforcing or stiffening areas;

FIG. 7 shows a schematic detailed view of an exemplary embodiment of a cargo loading system according to the invention;

FIG. 8 shows a schematic top view of an exemplary embodiment of a cargo loading system according to the invention;

FIG. 9 shows a schematic view of an exemplary embodiment of a cargo loading system according to the invention;

FIG. 10 shows an enlargement from FIG. 7;

FIG. 11 shows a schematic side view of an exemplary embodiment of a cargo loading system according to the invention;

FIG. 12 shows a schematic view of an exemplary embodiment according to a latch element according to the invention;

FIG. 13 shows a schematic view of an alternative exemplary embodiment according to a latch element according to the invention;

FIG. 14 shows a schematic cross-sectional view of an exemplary embodiment of a cargo loading system according to the invention;

FIG. 15 shows an enlargement of the schematic cross-sectional view of the exemplary embodiment of a cargo loading system according to the invention as shown in FIG. 16;

FIG. 16 shows a top view of a loading deck comprising a cargo loading system according to the invention with different segments;

FIG. 17 shows schematic overview of possible loading configurations having a cargo loading system according to the invention.

### DETAILED DESCRIPTION

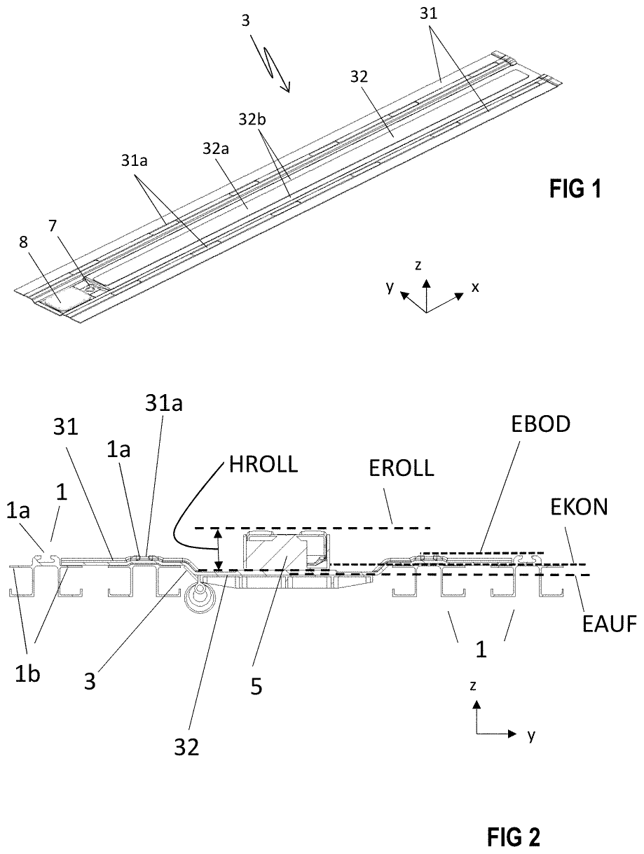

FIG. 1 shows a schematic view of an exemplary embodiment of a floor module 3 according to the invention. The floor module 3 extends substantially in the x-direction (longitudinal direction of the aircraft). In one exemplary embodiment, the floor module 3 has a length of about 126 inches (about 320 cm).

The floor module 3 has first and second support sections 31, wherein the support sections extend substantially planar in the longitudinal direction (x-direction) and in particular defining a support plane by their undersides.

Furthermore, the floor module 3 has a planar functional device receiving section 32 formed centrally between the support sections 31, wherein the functional device receiving section 32 extends in the longitudinal direction (x-direction) and forms a receiving plane EAUF. Thus, the functional device receiving section 32 is significantly lowered relative to the support sections 31. The sections 31, 32 extend substantially parallel to each other.

A functional device receiving section 32 can be understood as an area on which a functional device is mounted in a self-supporting manner, but also an arbitrarily designed area that creates free space downwards in the z-direction so that a functional device 4,5 can project into it.

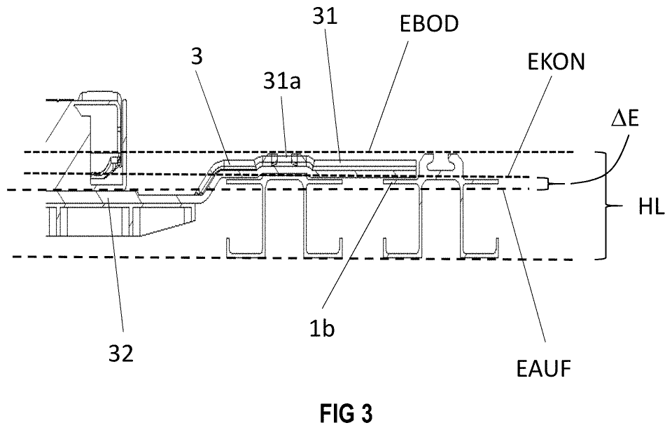

The floor module 3 is designed in such a way that the receiving plane EAUF (cf. FIGS. 2 and 3) extending parallel to the support sections 31 is clearly spaced downward from the support plane EKON. In the example shown, the receiving plane EAUF and support plane EKON have a distance ΔE of approx. 1.5 cm. There is thus a distance of about 1.9 cm (corresponding to about 0.75 inches) between cargo hold floor level EBOD and receiving plane EAUF, so that 2-inch functional devices or components can be used in the channel or on the functional device receiving section 32 if so-called 1.25-inch functional devices or components are predominantly used on the cargo deck.

Assuming that an assembly height HL of the perforated rail device 1 according to FIGS. 1, 2 and 3 amounts to approx. 5 cm, a relative percentage of 25% results in the already explained distance ΔE of approx. 1.5 cm. If the distance ΔE between the receiving plane EAUF and the support plane EKON is selected to be greater than 10%, the result is a distance ΔE greater than 0.5 cm.

In other exemplary embodiments, the distance ΔE between the receiving plane EAUF and the support plane EKON can be greater than 10%, in particular greater than 20% in particular greater than 30% of the mounting height HL (see FIG. 3) of the perforated rail device 1.

This distance ΔE can vary depending on the assembly height of the system components. The decisive factor is that system components with different system heights can be combined according to the invention.

The functional device receiving section 32 can serve as a drainage (channel) or drainage channel of liquid when mounted.

Therefore, in the exemplary embodiment according to FIG. 1, the floor module 3 has at least one drainage device 7.

The drainage device 7 can, for example, be designed as a hose and/or pipe connection.

The functional device receiving section 32 of the floor module may further comprise at least one inspection opening 8. In this case, the inspection opening 8 is preferably arranged in the vicinity of one end in the longitudinal direction of the floor module 3 and can be closed (fluid-tight) with a cover 8a.

The functional device receiving section 32 of the floor module 3 has a plateau 32a arranged centrally, so that channels 32b are formed on both sides of the plateau 32a. In this way, functional devices can be arranged (slightly) elevated on the plateau 32a and (at least predominantly) the channels 32b can be used as drainage channels.

Optionally, the plateau can also be designed to reinforce or stiffen the floor module 3.

The support sections 31 (each) have a plurality of (assembly) openings 31a extending in the longitudinal direction. The openings 31a have a width of about 35 mm. A length of an opening 31a is about 15 cm.

Alternatively, the openings 31a may have widths between 20 mm and 40 mm and/or have widths between 10 and 25 cm (between 4 and 10 inches).

A first end (in longitudinal direction) of the floor module 3 may have a raised connection area and/or a second end of the floor module 3 may have a lowered connection area. Alternatively or additionally, the connection areas may comprise clip-nuts to enable and/or support a connection of two floor modules.

Advantageously, the ends of the floor module are in any case designed in such a way that two floor modules 3 can be connected in an overlapping manner, and preferably screwed together, and can also be easily taken apart again. Fastening means (bolts, screws, or the like) can be provided for fixing the connection, depending on the requirements. Gluing the floor modules 3 together is also conceivable.

The connection areas can comprise one or more sealing lips so that (in each case) two floor modules 3 can be connected tightly, optionally even gas-tight.

FIG. 2 shows a schematic view of a cross-section of an exemplary embodiment of a floor module 3 according to the invention in mounted state or arranged on perforated rail devices 1. FIG. 3 shows a detailed enlargement of FIG. 2.

In the exemplary embodiment shown in FIG. 2 and FIG. 3, a roller drive unit 5 is arranged in the functional device receiving section 32 of the floor module 3.

The first and second support sections 31 of the floor module 3 rest flat on support sections 1b of the perforated rail device 1.

The support sections define the support plane EKON.

The functional device receiving section 32 forms a lower or recessed receiving plane EAUF in the z-direction (perpendicular to longitudinal direction x and to transverse direction y) (cf. in particular FIG. 3).

In this way, it is possible that a (maximum) roller height (in operating state) EROLL of a roller drive unit 5 can be adjusted (in relation to the cargo hold floor level EBOD) by a height ratio of the support plane EKON and the receiving plane EAUF of the floor module 3. The roller height (in operating state) EROLL corresponds to a (cargo) conveying level.

In this way, a (physical) height HROLL of the roller drive unit 5 can be compensated with respect to a cargo hold floor level EBOD.

The (effective) roller height HROLL is thus lowered by the floor module 3 by the difference between the height of the support plane EKON and the receiving plane EAUF.

FIG. shows 4a bottom view of the floor module 3.

The inspection opening 8 is closed by a cover 8a. A variety of fastening means (for example screws) can be provided for this purpose.

Advantageously, the cover 8a or the inspection opening 8 has a sealing lip at a corresponding edge so that the inspection opening 8 can be closed in a fluid-tight manner.

The inspection opening 8 is arranged and formed in such a way that one end of the cable 9, in particular a plug 6b and/or a socket 6a on the cable 9, and/or the drainage device 7 is accessible through the inspection opening 8.

Plug 6b and socket 6a on the cable are thus arranged per (respective) floor module. In the exemplary embodiment shown, the cable 9 extends beyond one end in the longitudinal direction of the floor module 3 and is terminated with a plug 6b. At the other end of the cable 9, a corresponding socket 6a is fixedly arranged near the inspection opening 8.

In this way, two floor modules 3 can be plugged together and plug/socket 6a, 6b can be conveniently connected (or disconnected). This connection or disconnection of plug/socket 6a, 6b can also be carried out, for example, after mounting/attaching a floor module 3 through the corresponding access possibility through the inspection opening 8.

The reinforcing element 5a can be provided below a roller drive unit 5 to distribute a force acting thereon (by containers). The reinforcing element 5a can be connected (for example screwed) to the floor module 3 and/or (directly) to the roller drive unit 5.

The reinforcing element 5a can be made, for example, of a (synthetic fiber) composite or even aluminum and can have multiple stabilizing ribs (for example, a honeycomb structure).

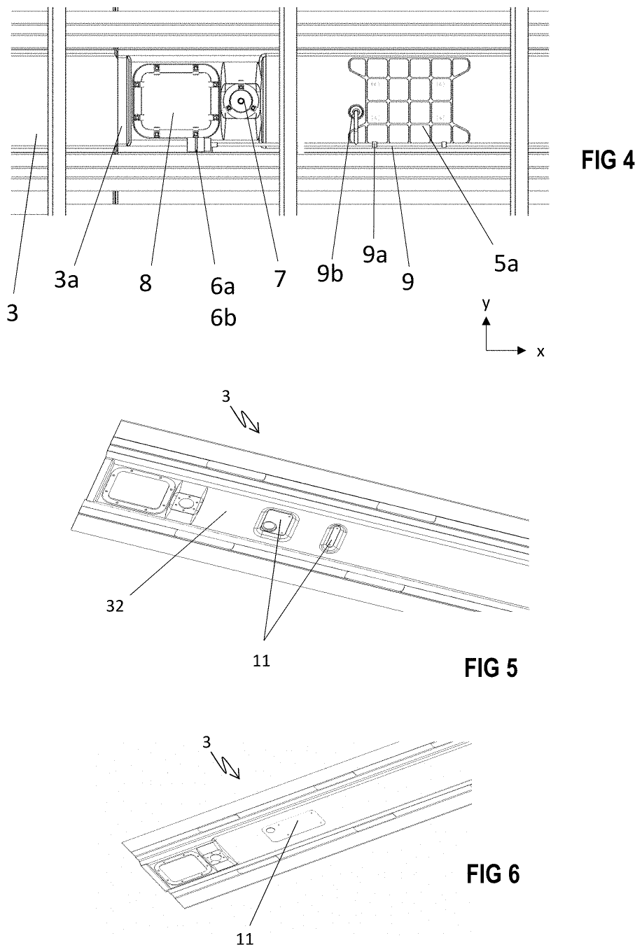

Furthermore, FIG. 4 shows a cable passage 9b as well as several cable fastening devices 9a. The cable fastening devices 9a guide the cable 9 along the floor module 3.

By means of a cable passage 9b, the cable 9 (or a branch thereof) can be led from the underside of the floor module 3 to its top side (for example to the roller drive unit 5 and its electrical supply).

The cable passage 9b preferably comprises a seal and/or is designed to be fluid-tight.

Two connected floor modules 3 are shown in FIG. 4. In the exemplary embodiment, the left floor module 3 engages under the right floor module 3 in a connection area 3a.

A sealing lip or the like can be arranged in the connection area 3a, so that the connection area 3a is designed to be fluid-tight as a whole.

FIGS. 5 and 6 (each) show schematic views of exemplary embodiments of a floor module 3 with alternative reinforcing or stiffening areas 11.

FIG. 5 shows different reinforcing or stiffening areas 11 on the floor module 3, which are arranged in the functional device receiving section 32.

The reinforcing or stiffening areas 11 have different geometries (for example different widths, lengths or heights). In this way, a reinforcing or stiffening area 11 can be adapted (in the geometric sense) and/or optimized (in terms of force distribution) to a functional device (not shown) to be arranged thereon or in the vicinity.

The reinforcing or stiffening areas 11 may be formed as an integral part of the floor module 3 or may be mounted to or within the floor module 3.

For example, in FIG. 6 a reinforcing plate is locally disposed in the functional device receiving section 32.

Alternatively, the reinforcing or stiffening areas 11 may be formed as cores within the floor module. Such a core can be made of the identical (or alternative) material as the rest of the floor module 3 and can be formed as a local thickening of the floor module 3. For example, by (locally) introducing foam cores or a local layer increase.

Alternatively or additionally, the cores within the floor module 3 may be locally structured (for example, honeycomb) to provide stiffening of the floor module.

In principle, it is possible for the reinforcing or stiffening areas 11 to have holes and/or cavities in order to save weight. Overall, however, they are such that they do not affect the fluid density of the functional device receiving section 32.

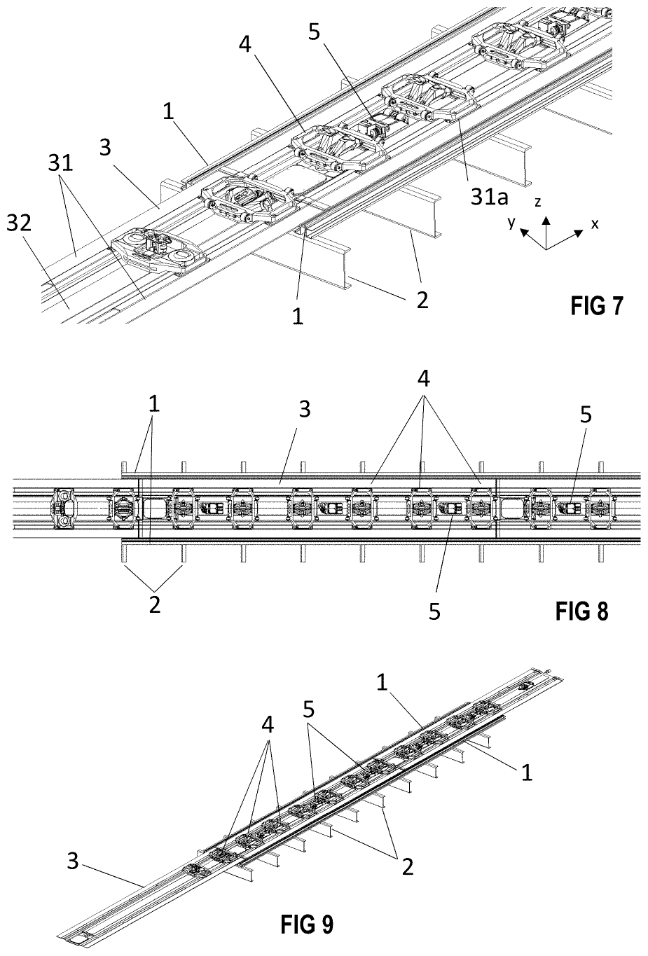

FIG. 7 shows a schematic detailed view of an exemplary embodiment of a cargo loading system.

A floor module 3 is supported on a pair of perforated rail devices 1.

The perforated rail devices 1 are, for example, seat rail devices of a passenger aircraft originally designed to support multiple passenger seats or rows of seats.

The perforated rail devices 1 are supported by aircraft cross members 2.

The support sections 31 of the floor modules 3 have a number of openings 31a, which are designed in such a way that they allow direct access to the respective (underlying) perforated rail device (1).

In particular, at least a partial section of an engagement slot 1a of the respective perforated rail device 1 is accessible through the openings 31a in order to anchor the floor module 3 itself and/or a functional device 4, 5 preferably spanning the floor module 3 at least partially in the perforated rail devices 1.

The functional devices 4, 5 may protrude (downward) into or be disposed in the functional device receiving section 32.

The openings 31a are formed or dimensioned to substantially correspond to the engagement slot 1a, thus allowing a positive fit between the floor module 3 and the perforated rail device 1.

FIG. 8 schematically shows a top view of an exemplary embodiment of a cargo loading system as shown in FIG. 7.

FIG. 9 shows an exemplary embodiment for a cargo loading system comprising several floor modules 3 arranged one behind the other.

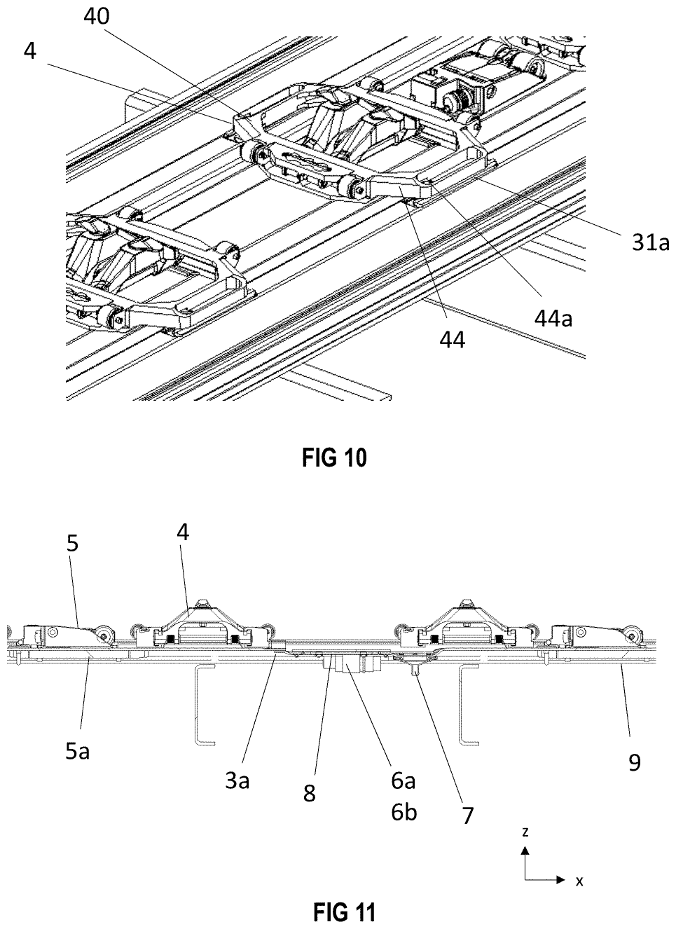

FIG. 10 shows an enlarged area from FIG. 7 to describe the anchoring of the latch elements 4 and the floor module 3 with the perforated rail devices 1.

The floor module 3 can be attached to the perforated rail devices 1 by means of fastening means (screws) and sealing tape.

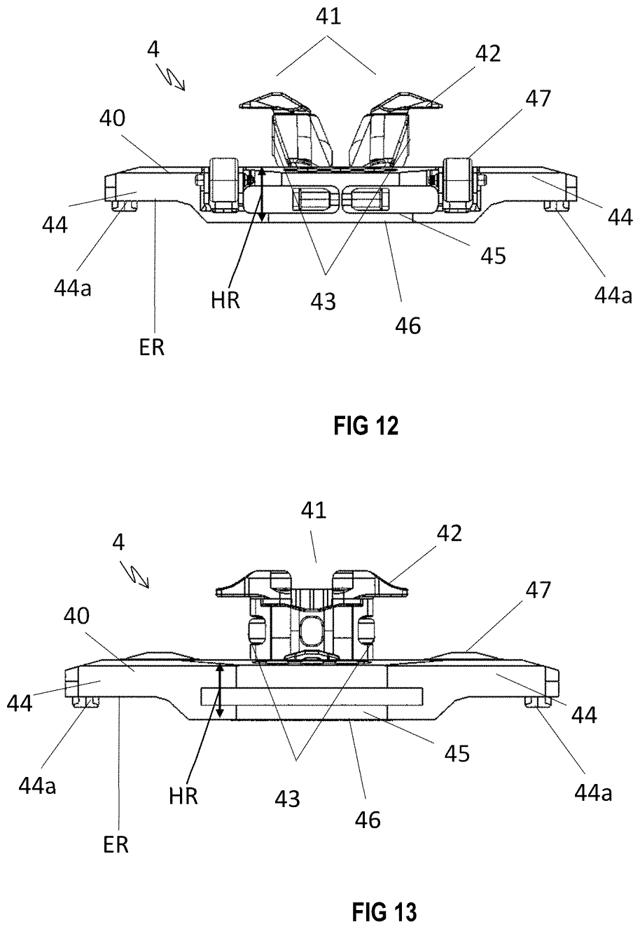

The latch elements 4 have a frame 40. Fastening devices 44a are arranged on the frame support sections 44 of the frame 40, which can be engaged with the perforated rail devices 1 (see also FIGS. 12 and 13) for mounting/fastening the frame 40.

For this purpose, fastening devices 44a of the latch elements 4 are inserted through the openings 31a in the engagement slot 1a of the perforated rail device 1 (see FIG. 3).

In this case, the engagement slot 1a is designed to correspond with the fastening devices 44a in such a way that the fastening devices 44a are hooked in or inserted in a first position and can then be displaced by a distance of about 1 cm into a locking position. A bolt attached to the frame 40 can be inserted into the engagement slot 1a in the locking position in such a way that the latch elements 4 are locked in the locking position, i.e. can no longer be removed or displaced. After the bolt is released, the latch elements 4 can be moved from the locking position to the first position and removed.

FIG. 11 shows an enlarged side view of an exemplary embodiment of a cargo loading system with functional devices 4, 5 and floor modules 3.

Two connected floor modules 3 are connected to each other via a connection area 3a. In the exemplary embodiment, the left floor module 3 engages under the right floor module 3 in a connecting area 3a.

A sealing lip or the like can be arranged in the connection area 3a, so that the connection area 3a is designed to be fluid-tight as a whole.

For the further features, reference is made to the previous explanations concerning the floor module 3.

The functional devices 4—the latch elements 4—are described below.

The latch elements 4, in particular center guide latch elements, are used in a cargo loading system as described above to secure or guide containers.

FIG. 12 shows an exemplary embodiment of a center guide latch element 4.

Preferably, the center guide latch element 4 has an integral frame 40.

Latches 41, which are preferably downwardly foldable, are arranged on the frame 40 for holding and/or guiding containers or the like at spaced intervals, each with a claw 42 and a stop surface 43.

The frame includes first and second frame support sections 44 for (flat) support and/or mounting on a pair of perforated rail devices 1.

The frame support sections 44 thereby define a frame support plane ER.

Fastening means 44a are disposed on the frame support sections 44, which are engageable with the perforated rail devices 1 (see, for example, FIG. 2) for mounting/fastening the frame 40.

In addition, the frame 40 includes a central section 45 within which the latches 41 are mounted, a lower end 46 of the central section 45 extending below that of the frame support plane ER.

In the exemplary embodiment shown, a distance between the stop surfaces 43 is between 7 cm and 12 cm, preferably between 9 and 11, further preferably about 10 cm (approximately 4 inches).

Load-bearing devices 47, in particular rollers, ball rollers or caster rollers, can be provided in the latch element. The load-bearing devices facilitate the movement of the containers across the latch element by carrying a (partial) load of the containers and defining the vertical position of the containers relative to the latch. The displaceability of the load-bearing devices allows the load-bearing devices to be arranged, for example, depending on the position of the latch in the latch element. The load-bearing devices can also be arranged in a removable manner, so that weight is saved when no load-bearing devices are required.

FIG. 13 shows an alternative embodiment of a latch element 4, which differs essentially in the shape (or number) of the latches 41 and the arrangement and type of load-bearing devices 47. In FIG. 13, the latch element 4 has a T-shaped latch 41.

The latch or latches 41 of the latch elements 4 of FIGS. 12 and 13 are preferably designed to be downwardly foldable. This means that they can be pivoted out of their shown position and countersunk in the central section 45.

In one exemplary embodiment, a frame height HR of the frame 40 in the central section 45 is approximately between 3 and 6 cm, preferably approximately 4.5 cm, more preferably approximately 1.75 inches. In other words, the latch element is designed to have a system height of about 5 cm.

The frame support sections 44 are formed significantly lower than the central section 45 of the frame 40. In particular, a height of the frame support section 44 corresponds to only between 40% and 70%, preferably 50%, further preferably 60% of the height of the central section 45.

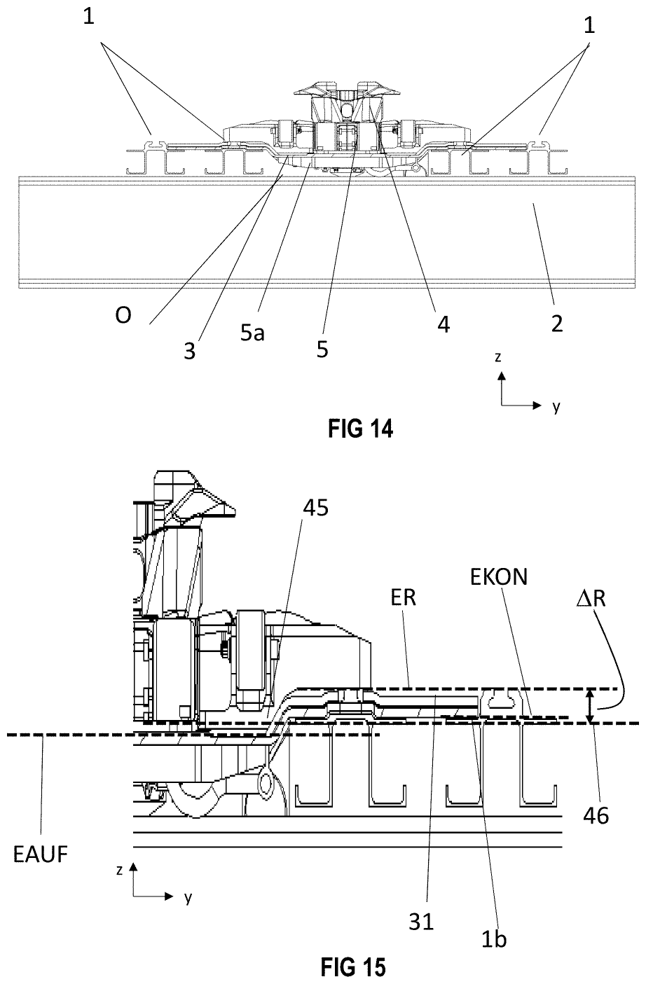

FIG. 14 shows a schematic cross-sectional view of an exemplary embodiment of a cargo loading system having a floor module 3 as well as a roller drive device 5 and a latch element, in particular a center guide latch element 4.

The fastening devices of the latch element or center guide latch element 4 are guided into engagement with the perforated rail device 1 through openings 31a in the support sections 31 (not shown) of the floor module.

The central section 45 (see FIG. 12 or 13) projects downward (negative z-direction) into the functional device receiving section 32 of the floor module 3.

FIG. 15 shows an enlarged section of the exemplary embodiment of FIG. 14.

The first and second support sections 31 of the floor module 3 rest on support sections 1b of the perforated rail device 1. In this case, the support sections 31 define a support plane EKON. The functional device receiving section 32 forms a lower receiving plane EAUF or a recessed receiving plane EAUF in the z-direction (perpendicular to the longitudinal direction x and to the transverse direction y) (see also FIG. 2).

The central section 45 (see FIG. 12 or 13) of the latch element 4 projects (downward, negative z-direction) into the functional device receiving section 32 of the floor module 3.

In particular, the central section 45 projects into the functional device receiving section 32 of the floor module 3 by a depth OR. The depth OR is the distance between the plane defined by the lower end 46 of the central section 45 and the frame support plane ER defined by the frame support section 44.

In this way, an effective frame height HR (see FIG. 12 or 13) can be reduced by the amount of the depth OR when viewed from the cargo floor. This results in comparatively slim geometries on the floor side despite comparatively solid frame thicknesses.

The comparatively flat support sections 44 also reduce the weight of the frame without any particular loss in terms of the stability of the frame 40.

Overall, this results in a solid, stable, compact but lightweight cargo loading system.

It can also be seen from the cross-sectional views in the exemplary embodiment according to FIGS. 14 and 15 that a usable empty space O remains between lowered areas of the floor module 3 and the perforated rail devices 1, which can optionally be used for (additional) electrical and/or fluid-conducting lines and/or piping.

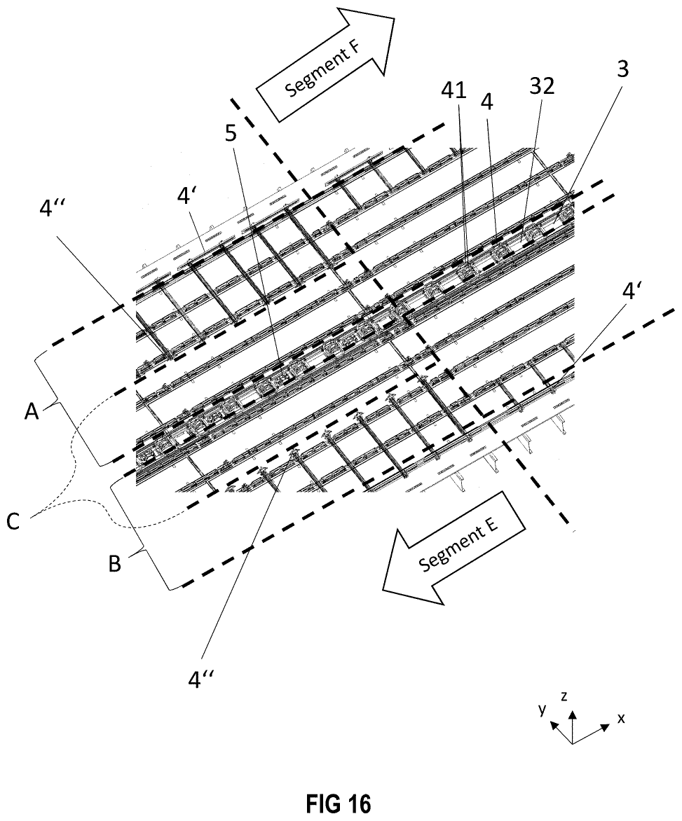

FIG. 16 shows a partial section of a cargo deck according to the invention, with all necessary components shown across the entire width of the cargo deck.

In this case, the cargo loading system is arranged on a passenger deck of an aircraft that has been converted into a cargo deck.

For this purpose, the original floor modules of the passenger deck are dismantled and then several modified floor modules 3 are arranged between perforated rail devices 1.

The modified floor modules 3 are finally bolted to support structures, e.g. the perforated rail devices 1, and the center guide latch elements 4 are attached to the partial sections of the engagement slots 1a of the perforated rail devices 1.

In this case, the center guide latch elements 4 and the modified floor modules 3 are designed and arranged in such a way that, at least in sections, they project significantly into an area below the dismantled original floor modules.

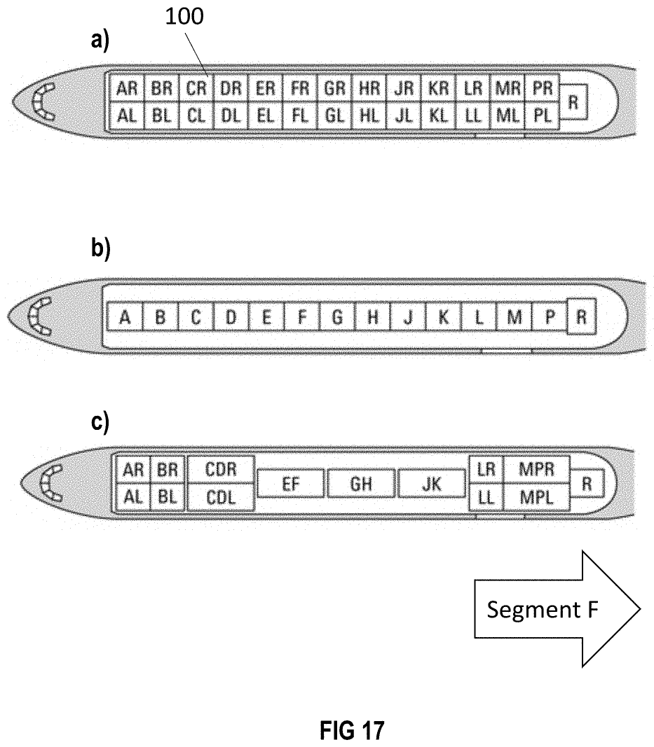

The cargo loading system is designed to assume different configurations—see also the following explanations for FIG. 17.

For this purpose, center guide latch elements 4, outer side guide elements 4′ (preferably displaceable) and inner side guide elements 4″ (downwardly foldable) are set up and designed for setting a first or a second loading configuration (or a combination thereof).

Possible loading configurations for the cargo loading system according to the invention are shown in FIG. 17 (non-exhaustive illustration).

In first loading configuration a), a side-by-side loading configuration is shown. In this configuration, the ULDs 100 are loaded in two rows across the entire width of the cargo deck.

A distance between the container rows (i.e. between two containers adjacent in the transverse direction) corresponds to the distance between the stop surfaces 43 of the latches 41. Here, for example, this is approx. 4 inches or approx. 10 cm.

In the second loading configuration b), a centerline loading configuration is implemented. In this configuration, the ULDs 100 are loaded in a row along the entire length of the cargo deck. This configuration is particularly suitable for transporting heavy ULDs 100 with high area loads.

A third loading configuration c) is a mixed configuration with partial centerloading. This means that lighter ULDs 100 can be loaded in the bow and stern and heavier ULDs 100 in the center.

In the second loading configuration a), the ULDs 100 are held and guided centrally on the cargo lane C (cf. FIG. 16). Inner side guides 4″ are in an upright position and delimit the cargo lane C.

In the first loading configuration, the ULDs 100 are held and guided in pairs side by side on the cargo lanes A and B (FIG. 16) on the cargo loading system, as already explained. For this purpose, the center guide latch elements 4 and the side guide elements 4′ are in a set-up position. The inner lateral guides 4″ are lowered.

Furthermore, the cargo loading system has roller drive units 5 for conveying containers in loading configuration b). The roller drive units are very advantageous for conveying heavy ULDs in this configuration.

All functional devices 4, 4′, 4″, 5 are attached to the perforated rail devices 1 in a preferred exemplary embodiment.

The cargo deck can be divided into different segments, as shown in FIG. 16. In the exemplary embodiment according to FIG. 16, there is a segment E in the front area of the aircraft and a segment F in the rear area of the aircraft.

In segment E, roller drive units 5 for powered conveying of heavy ULDs 100 are arranged on the floor module 3 in the center of the cargo deck.

No roller drive units 5 are arranged in segment F, so that lighter ULDs can be loaded here by hand. The inner lateral guide elements 4″ are also missing in segment F.

According to the invention, therefore, differently equipped segments can be offered and set up on the cargo deck. This allows the cargo loading system to be optimally adapted to the operator's requirements profile. Unnecessary components are not installed to reduce acquisition costs and weight.

For example, a cargo system can be equipped so that only the first loading configuration a) and third loading configuration c) are possible. In this exemplary embodiment, the inner side guide elements 4″ may be missing in segment F, as already shown in FIG. 16.

Depending on requirements, further loading configurations can be offered. For example, with the equipment shown in FIG. 16, it is possible to load ULDs 100 which extend over the entire width (y-direction) of the cargo space, since the center guide latch elements 4 can be folded down. Furthermore, insofar as displaceable outer side guide elements 4′ are provided, centric loading similar to the second loading configuration b) can be offered for different dimensions of the ULDs 100.

It should be noted at this point that, particularly with reference to the details shown in the drawings, features described in the context of separate embodiments can also be implemented in combination in a single embodiment. Conversely, various features that are described in the context of a single embodiment can also be implemented in multiple embodiments separately or in any suitable subcombination.
1 Perforated rail device
1a Engagement slot
1b Support sections
2 Cross member
3 Floor module
3a Connection area
4 Center guide latch elements
4′, 4″ Side guide element
5 Roller drive unit
5a Reinforcing element
6a,b Plug, socket
7 Drainage device
8 Inspection opening
8a Cover
9 Cable
9a Cable fastening device
9b Cable passage
11 Stiffening area
31 Support section
31a Openings
32 Functional device receiving section
32a Plateau
32b Channel
40 Frame
41 Latch
42 Claw
43 Stop surfaces
44 Frame support sections
44a Fastening devices
45 Central section
46 Lower end of the central section
47 Load-bearing devices
100 ULD (pallet or container)
EAUF Receiving plane
EKON Support plane
EBOD Cargo hold floor level
E Distance between receiving plane EAUF and support plane EKON
ER Frame support plane
E, F Segments
HR Frame height
HL Mounting height of the perforated rail device
EROLL Roller height
HROLL Height
O Empty space
x Longitudinal direction of the aircraft
y Transverse direction of the aircraft (perpendicular to longitudinal direction x)
z Height direction of the aircraft (perpendicular to x,y)

1. An integral floor module for a cargo deck comprising:
first and second support sections for support on a perforated rail device, wherein the first and second support sections extend in a longitudinal direction and define a support plane; and
a flat functional device receiving section, which is formed between the support sections, wherein the functional device receiving section extends in the longitudinal direction and defines a receiving plane; wherein the receiving plane is spaced apart from the support plane.

2. The floor module according to claim 1, wherein a first end of the floor module has a raised connection area and/or a second end of the floor module has a downwardly lowered connection area to allow connection of the floor module with a further floor module in an overlapping manner.

3. The floor module according to claim 1, wherein the support sections each have at least one opening configured to provide, in an arranged state of the floor module, direct access to the respective perforated rail device in order to anchor the floor module itself and/or a functional unit.

4. The floor module according to claim 1, wherein the floor module has on an underside a plurality of cable fastening devices for guiding at least one cable.

5. The floor module according to claim 1, wherein the functional device receiving section or at least a partial area of the functional device receiving section is configured for drainage of liquid.

6. The floor module according to claim 5, wherein the functional device receiving section comprises at least one drainage device and/or
at least one inspection opening arranged adjacent one end in the longitudinal direction of the floor module and closable in a fluid-tight manner with a cover.

7. The floor module according to claim 1, wherein at least one reinforcement area for reinforcing or stiffening the floor module is arranged along the functional device receiving section.

8. A cargo loading system for an aircraft, comprising:
a plurality of perforated rail devices extending in a longitudinal direction of the aircraft; and
at least one floor module according to claim 1, arranged on at least one pair of perforated rail devices of the plurality of perforated rail devices.

9. The cargo loading system according to claim 8, wherein the support sections each have at least one opening configured to provide, in an arranged state of the floor module, direct access to a respective one of the pair of perforated rail devices in order to anchor the floor module itself and/or a functional unit, and wherein at least one of the pair of perforated rail devices has sections of engagement slots in which the openings correspond in the arranged state of the floor module engage.

10. The cargo loading system according to claim 8, wherein at least two floor modules are connected to one another in the longitudinal direction in a partially overlapping manner in such a way that the respective functional device receiving sections or partial areas thereof form a drainage channel for draining off liquid.

11. The cargo loading system according to claim 8, wherein the cargo loading system further comprises at least one of a plurality of roller drive units, a plurality of longitudinal guide latch elements, and a plurality of central guide latch elements fixed to the perforated rails devices.

12. The cargo loading system according to claim 11, wherein center guide latch elements and side guide latch elements are arranged and formed for setting first and second loading configurations, wherein in the first loading configuration containers and/or pallets are centered and in the second loading configuration containers are held and guided in pairs side by side on the cargo loading system.

13. The cargo loading system according to claim 12, wherein different loading configurations can be set in sections in the longitudinal direction of the aircraft.

14. The cargo loading system according to claim 12, wherein the center guide latch elements each comprise at least one latch, wherein abutment surfaces of the at least one latch are spaced apart from one another.

15. The cargo loading system according to claim 11, wherein roller drive units are arranged between successive center guide latch elements.

16. The cargo loading system according to claim 14, wherein the at least one latch of the center guide latch element is pivotable from a rest position to a raised position to delimit a left cargo lane and a right cargo lane for a side-by-side loading configuration.

17. The cargo loading system according to claim 16, wherein the roller drive units each comprise an optical sensor for detecting a ULD, wherein each roller drive unit can be activated individually based on the signals of the sensor and the roller drive units are arranged between the center guide latch elements in such a way that the roller drive units cannot be activated in the raised position of the latches of the center guide latch elements.

18. A latch element for securing cargo items on the cargo loading system according to claim 8, the latch element comprising:
a frame,
at least one latch attached to the frame for holding and/or guiding the cargo items in a spaced manner, each latch having a claw and a stop surface,
wherein the frame comprises:
first and second frame support sections for supporting and/or mounting on a pair of perforated rail devices, wherein the frame support sections define a frame support plane; and
a central section within which the latches are mounted, wherein a lower end of the central section extends below the frame support plane.

19. A method for converting a passenger deck into a cargo deck:
dismantling at least a subset of original floor modules of the passenger deck;
arranging one or more modified floor modules according to claim 1 between at least two perforated rail devices;
fastening the modified floor modules to the perforated rail devices; and
fastening at least one functional device to at least one of the perforated rail devices;
wherein the functional device and/or the modified floor modules are formed and arranged in such a way that they project at least in sections into an area below the dismantled original floor modules.
